(19) United States
(12) Patent Application Publication
(10) Pub. No.: US 2022/0156003 A1
(43) Pub. Date: May 19, 2022

(54) CONTROLLER AND OPERATION METHOD THEREOF

(71) Applicant: SK hynix Inc., Gyeonggi-do (KR)

(72) Inventor: Gi Pyo UM, Gyeonggi-do (KR)

(21) Appl. No.: 17/322,019

(22) Filed: May 17, 2021

(30) Foreign Application Priority Data
Nov. 18, 2020 (KR) 10-2020-0154604

(51) Int. Cl. G06F 3/06

(52) U.S. Cl. CPC G06F 3/0659; G06F 3/0656; G06F 3/0673; G06F 3/0604; G06F 3/0631

(57) ABSTRACT

A controller that controls a memory device, the controller includes: a buffer including a plurality of segments; a host interface configured to determine a command group of a command from a host on the basis of an attribute of the command; and a buffer manager configured to allocate a free segment among the plurality of segments in response to a segment allocation request from the host interface, wherein the host interface further processes data associated with the command by using the allocated segment.

### CROSS-REFERENCE TO RELATED APPLICATION

This application claims priority under 35 U.S.C. § 119 to Korean Patent Application No. 10-2020-0154604 filed on Nov. 18, 2020, which is incorporated herein by reference in its entirety.

### BACKGROUND

### 1. Field

Various embodiments relate to a controller that controls a memory device.

### 2. Discussion of the Related Art

The computer environment paradigm has been transitioning to ubiquitous computing, which enables computing systems to be used virtually anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Since they have no moving parts, memory systems provide advantages such as excellent stability and durability, high information access speed, and low power consumption. Examples of memory systems having such advantages include universal serial bus (USB) memory devices, memory cards having various interfaces, and solid state drives (SSD).

### SUMMARY

Various embodiments of the present disclosure are directed to providing a controller capable of substantially preventing command processing performance degradation by preventing a problem which occurs when a command having a certain attribute occupies all buffer resources, and an operation method thereof.

Various embodiments s of the present disclosure are directed to providing a controller capable of efficiently using buffer resources by flexibly allocating the buffer resources according to an attribute of a command, and an operation method thereof.

The technical problems to be achieved by the within embodiments are not limited to the technical problems described above, and other technical problems may be inferred from the following embodiments.

In accordance with an embodiment of the present disclosure, a controller that controls a memory device, the controller includes: a buffer including a plurality of segments; a host interface configured to determine a command group of a command from a host on the basis of an attribute of the command; and a buffer manager configured to allocate a free segment when there is available free segment among the plurality of segments in response to a segment allocation request from the host interface, wherein the host interface further processes data associated with the command by using the allocated segment.

The host interface may further provide the buffer manager with a buffer identifier (ID) allocation request to acquire a buffer ID from the buffer manager, and provide the acquired buffer ID to the buffer manager together with the segment allocation request, and process the data associated with the command by accessing the allocated segment according to the acquired buffer ID after the buffer manager allocates the free segment for the buffer ID.

The host interface may further provide the buffer manager with a group ID for identifying the command group of the command together with the segment allocation request.

The controller may further include: a processor configured to allocate group IDs to command groups and determine a maximum number of segments, which are allowed for a corresponding command group, for each group ID.

The processor may determine the maximum number of segments for each group ID to be less than a number of all segments included in the buffer.

The processor may dynamically determine the maximum number of segments for each group ID on the basis of workload for each command group.

The host interface may further determine the group ID of the command on the basis of a type of the command.

The host interface may further determine the group ID of the command on the basis of a type of the command and an attribute of the data associated with the command.

The host interface may further determine the group ID of the command differently for each command.

The buffer manager may further determine a number of free segments to be allocated for the command on the basis of a maximum number of segments allowed for the group ID of the command, a current number of segments already allocated for the group ID, a number of segments required for processing the command and a number of free segments available in the buffer, and allocate the free segment for as many as the determined number of free segments to be allocated for the command.

The buffer manager may further determine a number of segments available for the group ID on the basis of the maximum number of segments allowed for the group ID of the command and the current number of segments already allocated for the group ID, and determine, as the number of free segments to be allocated for the command, a smallest number among the number of segments available for the group ID, the number of segments required for the group ID, and the number of free segments available in the buffer.

The buffer manager may further provide, in response to the segment allocation request, an error signal to the host interface without the allocating of the free segment when the number of available segments for the group ID or the number of free segments available in the buffer is ‘0’.

The buffer manager may further determine the number of segments required for the group ID on the basis of a size of the data associated with the command and a size of the segment.

In accordance with an embodiment of the present disclosure, an operation method of a controller that controls a memory device, the operation method includes: determining a command group of a command from a host on the basis of an attribute of the command; allocating a free segment among a plurality of segments included in a buffer of the controller; and processing data associated with the command by using the allocated segment.

The operation method may further include: allocating a buffer ID corresponding to the command, wherein the allocating of the free segment includes: allocating the free segment for the buffer ID, and the processing of the data associated with the command by using the allocated segment includes: accessing the allocated segment according to the buffer ID after the allocating of the free segment for the buffer ID.

The operation method may further include: determining a group ID for identifying the command group of the command.

The operation method may further include: allocating group IDs to command groups; and determining a maximum number of segments, which are allowed for a corresponding command group for each group ID, and the maximum number may be less than the number of all segments included in the buffer.

The determining of the maximum number of segments may include: dynamically determining the maximum number of segments for each group ID on the basis of workload for each command group.

The allocating of the free segment may include: allocating the free segment for as many as a number that is determined on the basis of a maximum number of segments allowed for the group ID of the command, a current number of segments already allocated for the group ID, a number of segments required for processing the command, and a number of free segments available in the buffer.

In accordance with an embodiment of the present disclosure, an operating method of a controller, the operating method includes: allowing, within a buffer comprising plural segments, a size for a request group; allocating, within the allowed size, one or more available segments among the segments in response to a request belonging to the request group; and controlling, with the allocated segments, a memory device to perform an operation in response to the request, wherein the allowed size is less than a whole size of the buffer.

In accordance with the present disclosure, it is possible to provide a controller capable of substantially preventing command processing performance degradation by preventing a problem which occurs when a command having a certain attribute occupies all buffer resources, and an operation method thereof.

In accordance with the present disclosure, it is possible to provide a controller capable of efficiently using buffer resources by flexibly allocating the buffer resources according to an attribute of a command, and an operation method thereof.

Effects achievable in the present disclosure are not limited to the aforementioned effects and other unmentioned effects will be clearly understood by those skilled in the art to which the present disclosure pertains from the following description.

### BRIEF DESCRIPTION OF THE DRAWINGS

FIG. 1 is a diagram schematically illustrating an example of a data processing system including a memory system in accordance with an embodiment of the present disclosure.

FIG. 2 is a diagram illustrating a buffer and a buffer manager in accordance with the embodiment of the present disclosure.

FIG. 3 is a diagram illustrating a buffer identifier (ID) allocation table stored in a memory by a buffer ID manager.

FIG. 4 is a diagram illustrating a group segment table stored in the memory by a group ID manager.

FIG. 5 is a diagram illustrating a segment allocation table stored in the memory by a segment manager.

FIG. 6 is a diagram for describing an operation of the buffer manager according to a buffer ID allocation request.

FIG. 7 is a diagram for describing an operation of the buffer manager according to a segment allocation request.

FIG. 8A and FIG. 8B are diagrams for describing an operation of a controller for a command from a host.

### DETAILED DESCRIPTION

Hereinafter, various embodiments of the present disclosure will be described with reference to the accompanying drawings. However, the present disclosure is not limited to the embodiments disclosed below, but may be configured in various different forms. The embodiments are provided to bring the disclosure of the present disclosure to perfection and assist those skilled in the art to completely understand the scope of the present disclosure.

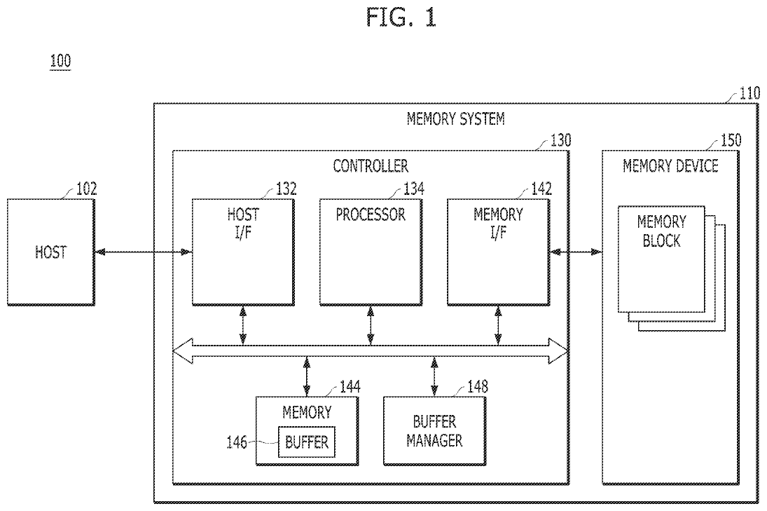

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include any of various portable electronic devices such as a mobile phone, MP3 player and laptop computer, or any of various non-portable electronic devices such as a desktop computer, a game machine, a television (TV), and a projector.

The host 102 may include at least one operating system (OS), which may manage and control overall functions and operations of the host 102, and provide operation between the host 102 and a user using the data processing system 100 or the memory system 110. The OS may support functions and operations corresponding to the use, purpose, and usage of a user. For example, the OS may be divided into a general OS and a mobile OS, depending on the mobility of the host 102. The general OS may be divided into a personal OS and an enterprise OS, depending on the environment of a user.

The memory system 110 may operate to store data for the host 102 in response to a request of the host 102. Non-limiting examples of the memory system 110 may include a solid state drive (SSD), a multi-media card (MMC), a secure digital (SD) card, a universal serial bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC, and the like. The SD card may include a mini-SD card and micro-SD card.

The memory system 110 may be embodied as various types of storage devices. Examples of such storage devices may include, but are not limited to, volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM or ReRAM) and a flash memory. The flash memory may have a 3-dimensional (3D) stack structure.

The memory system 110 may include a controller 130 and a memory device 150. The memory device 150 may store data for the host 102, and the controller 130 may control data storage into the memory device 150.

The controller 130 and the memory device 150 may be integrated into a single semiconductor device. For example, the controller 130 and the memory device 150 may be integrated as one semiconductor device to constitute a solid state drive (SSD). When the memory system 110 is used as an SSD, the operating speed of the host 102 connected to the memory system 110 can be improved. In addition, the controller 130 and the memory device 150 may be integrated as one semiconductor device to constitute a memory card. For example, the controller 130 and the memory device 150 may constitute a memory card such as a personal computer memory card international association (PCMCIA) card, compact flash (CF) card, smart media (SM) card, memory stick, multimedia card (MMC) including reduced size MMC (RS-MMC) and micro-MMC, secure digital (SD) card including mini-SD card, micro-SD card and SDHC card, or universal flash storage (UFS) device.

Non-limiting application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a program operation, and provide data stored therein to the host 102 through a read operation. The memory device 150 may include a plurality of memory blocks each of which may include a plurality of pages, and each of the pages may include a plurality of memory cells coupled to a word line. In an embodiment, the memory device 150 may be a flash memory. The flash memory may have a 3-dimensional (3D) stack structure.

The controller 130 may include a host interface (I/F) 132, a processor 134, an error correction code (ECC) component 138, a Power Management Unit (PMU) 140, a memory I/F 142, a memory 144 and a buffer manager 148 all operatively coupled via an internal bus.

The host I/F 132 may be configured to process a command and data of the host 102, and may communicate with the host 102 through one or more of various interface protocols such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (PATA), enhanced small disk interface (ESDI) and integrated drive electronics (IDE).

The host I/F 132 may be driven through firmware referred to as a host interface layer (HIL) in order to exchange data with the host.

The memory I/F 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the memory I/F 142 may generate a control signal for the memory device 150 and process data to be provided to the memory device 150 under the control of the processor 134. The memory I/F 142 may work as an interface (e.g., a NAND flash interface) for processing a command and data between the controller 130 and the memory device 150. Specifically, the memory I/F 142 may support data transfer between the controller 130 and the memory device 150.

The memory I/F 142 may be driven through firmware referred to as a flash interface layer (FIL) in order to exchange data with the memory device 150.

The processor 134 may control the overall operations of the memory system 110. The processor 134 may drive firmware to control the overall operations of the memory system 110. The firmware may be referred to as flash translation layer (FTL). Also, the processor 134 may be realized as a microprocessor or a central processing unit (CPU).

The processor 134 may drive the FTL and perform a foreground operation corresponding to a request received from the host. For example, the processor 134 may control a write operation of the memory device 150 in response to a write request from the host and control a read operation of the memory device 150 in response to a read request from the host.

Also, the controller 130 may perform a background operation on the memory device 150 through the processor 134, which is realized as a microprocessor or a CPU. For example, the background operation performed on the memory device 150 may include a garbage collection (GC) operation, a wear-leveling (WL) operation, a map flush operation, or a bad block management operation.

The memory 144 may serve as a working memory of the memory system 110 and the controller 130, and store data for driving the memory system 110 and the controller 130. The controller 130 may control the memory device 150 to perform read, program and erase operations in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be embodied by a volatile memory. For example, the memory 144 may be embodied by static random access memory (SRAM) or dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The memory 144 may include a buffer 146 in order to store data for performing an operation such as write and read between the host 102 and the memory device 150. The buffer 146 may include a plurality of segments.

A buffer manager 148 may allocate the buffer 146 in units of segments in response to a request from the host I/F 132, the processor 134, or the memory I/F 142.

As an example, in response to a write command from the host 102, the host I/F 132 may request at least one segment from the buffer manager 148 in order to buffer write data received from the host 102. The buffer manager 148 may allocate at least one segment for the write command in response to the request from the host I/F 132.

As an example, in response to a read command from the host 102, the host I/F 132 may request at least one segment from the buffer manager 148 in order to buffer read data outputted from the memory device 150. The buffer manager 148 may allocate at least one segment for the read command in response to the request from the host I/F 132.

When the buffer manager 148 allocates a segment for the command without considering the attribute of the command, one command or commands having substantially the same attribute may monopolize segments in the buffer 146. For example, the host I/F 132 may receive a write command for write data having a size equal to or larger than that of the buffer 146 from the host 102. When the buffer manager 148 allocates all the segments included in the buffer 146 for the write command in order to buffer the write data, the write command may monopolize the segments.

In the state in which all the segments have been allocated for the write command, when the host I/F 132 requests a segment for the read command, the buffer manager 148 may not allocate the segment for the read command until the processing of the write command is completed and the allocation of the allocated segments is released.

The memory I/F 142 may buffer the read data from the memory device 150 into the buffer 146 at the same time that the host I/F 132 buffers write data in the buffer 146. However, when the buffer manager 148 does not allocate the segment for the read command, the memory I/F 142 may not buffer the read data into the buffer 146 until the processing of the write command is completed. When the memory I/F 142 does not process the read command until the processing of the write command is completed, the read operation performance of the memory system 110 may be degraded.

Therefore, the buffer manager 148 is required to allocate a plurality of segments under the condition that a command having one attribute does not monopolize the segments in the buffer 146.

In accordance with an embodiment of the present disclosure, on the basis of an attribute of a command received from the host 102, the host I/F 132 may determine a command group of the command. The host I/F 132 may provide a segment allocation request to the buffer manager 148 together with information on the command group. The buffer manager 148 may refer to the information on the command group and allocate segments to the command group under the restriction of the maximum number of segments that are allowed for the command group.

For example, the attribute of the command may be determined according to the type of the command. For example, the read command and the write command may belong to different command groups as commands having different attributes.

The host I/F 132 may receive a write command for write data having a size equal to or greater than that of the buffer 146 from the host 102. The host I/F 132 may provide a segment allocation request for the write command to the buffer manager 148. The buffer manager 148 may allocate a restricted number of segments, instead of allocating all the segments in the buffer 146, in response to the segment allocation request.

When the read command is received from the host 102, the host I/F 132 may provide a segment allocation request for the read command to the buffer manager 148. Even before the processing of the write command is completed, the buffer manager 148 may allocate a segment, which has not been allocated for the write command, for the read command. By using the segment allocated for the read command, the memory I/F 142 may process the read command even before the processing of the write command is completed. Accordingly, it is possible to substantially prevent a problem in that a command having one attribute monopolizes the segments in the buffer 146 and thus processing performance of a command having another attribute is degraded.

The present disclosure is not limited to the fact that an attribute of a command is determined according to the type of the command. As an example, an attribute of a command may also be determined according to the type of the command and an attribute of data corresponding to the command. The host I/F 132 may determine a sequential read command, a random read command, a sequential write command, and a random write command as different command groups. As an example, different commands may be determined as commands having different attributes. The host I/F 132 may determine the respective commands from the host 102 as different command groups.

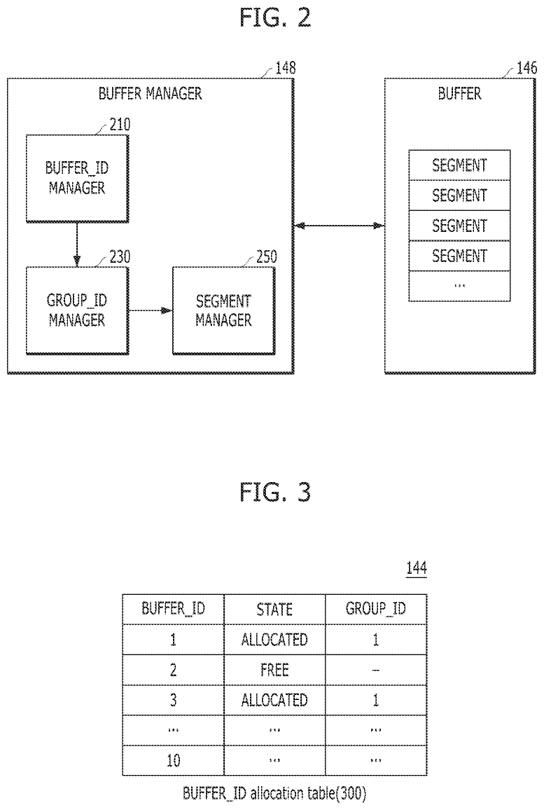

The buffer 146 and the buffer manager 148 described with reference to FIG. 1 will be described in detail with reference to FIG. 2.

FIG. 2 is a diagram illustrating the buffer 146 and the buffer manager 148 in accordance with the embodiment of the present disclosure.

The buffer 146 may include a plurality of segments. For example, the buffer 146 may include a plurality of segments each having a size of 4 KB.

The buffer manager 148 may allocate the segments for commands. The buffer manager 148 may include a buffer ID manager 210, a group ID manager 230, and a segment manager 250.

The buffer ID manager 210 may allocate a buffer ID in response to a buffer ID allocation request from the host I/F 132, and provide the allocated buffer ID to the host I/F 132.

The host I/F 132 may provide a group ID of a command to the buffer manager 148 together with the buffer ID allocation request, thereby acquiring a buffer ID for the command. The buffer manager 148 may allocate a segment to the buffer ID corresponding to the command, thereby allocating a segment for the command. Furthermore, the host I/F 132, the processor 134, and the memory I/F 142 may use the buffer ID in order to access the segment allocated for the command.

For example, the host I/F 132 may receive a read command from the host 102, and provide a buffer ID allocation request for the read command to the buffer manager 148 together with a group ID of the read command. The buffer ID manager 210 may provide a buffer ID to the host I/F 132 in response to the buffer ID allocation request.

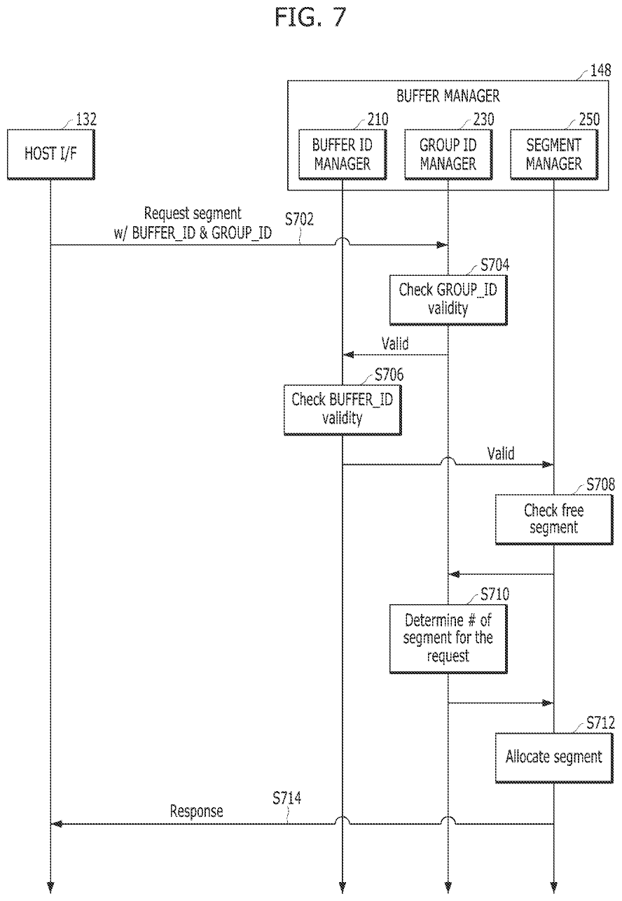

The host I/F 132 may provide a segment allocation request for the received buffer ID to the buffer manager 148. When a segment allocation completion response Response (See FIG. 7) is received from the buffer manager 148, the host I/F 132 may provide the buffer ID to the memory I/F 142 together with the read command.

The memory I/F 142 may use the buffer ID to buffer read data, which is outputted from the memory device 150 in response to the read command, in segments allocated for the buffer ID. The host I/F 132 may use the buffer ID to provide the buffered data to the host 102 from the segments allocated for the buffer ID.

The buffer ID manager 210 may store, in the memory 144, buffer ID allocation information including information regarding the allocation or non-allocation of buffer IDs, and update the buffer ID allocation information when the buffer ID is allocated or deallocated.

The group ID manager 230 may determine the number of free segments to be allocated for a command under the restriction of the maximum number of segments that are allowed for a command group to which the command belongs.

On the basis of the number of segments required for processing a command, the maximum number of segments that are allowed for a command group of the command, to which the command belongs, and the current number of segments already allocated for the command group, the group ID manager 230 may determine whether to allocate a segment for the command. When it is determined to allocate the free segment for the command, the group ID manager 230 may determine the number of free segments to be allocated for the command.

The group ID manager 230 may store, in the memory 144, group segment information including information on the number of segments already allocated for each command group and information on a maximum number of segments that are allowed for each command group, and determine the number of free segments to be allocated for each command by referring to the group segment information.

The segment manager 250 may allocate free segments, which correspond to the number of segments to be allocated for the command. The segment manager 250 may store, in the memory 144, segment allocation information including whether each segment has been allocated, and a buffer ID and a group ID associated with an allocated segment, and allocate a free segment, which is not currently allocated, for the command by referring to the segment allocation information.

Examples of the buffer ID allocation information, the group segment information, and the segment allocation information will be described in detail with reference to FIG. 3 to FIG. 5.

FIG. 3 is a diagram illustrating a buffer ID allocation table 300 stored in the memory 144 by the buffer ID manager 210.

The buffer ID allocation table 300 may include, as the buffer ID allocation information, state information STATE indicating allocation or non-allocation for each buffer ID and group ID information group ID corresponding to an allocated buffer ID. In the example of FIG. 3, the buffer ID allocation table 300 may include 10 buffer IDs. buffer ID ‘1’ and buffer ID ‘3’ may be in a state of being allocated for commands determined as group ID ‘1’. buffer ID ‘2’ may be in an unallocated state.

The buffer ID manager 210 may allocate an unallocated buffer ID by referring to the buffer ID allocation table 300 in response to the buffer ID allocation request from the host I/F 132, and update the buffer ID allocation table 300.

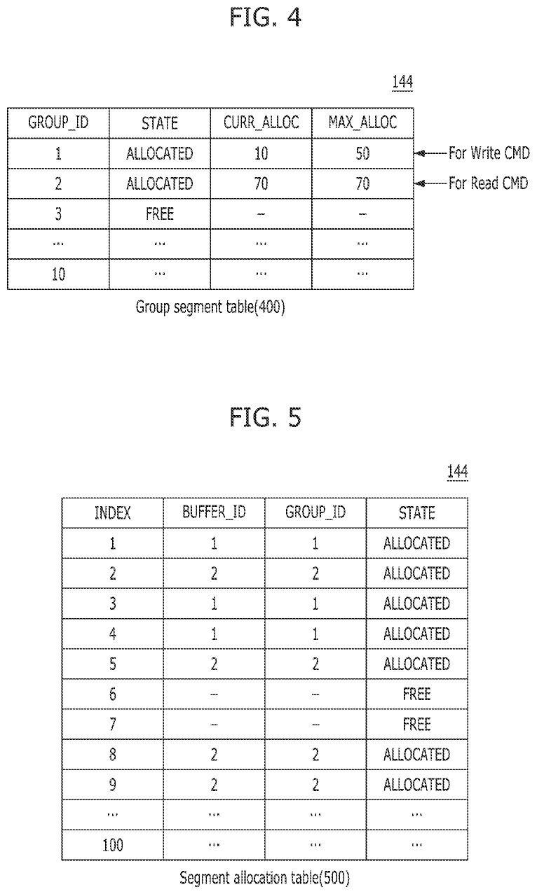

FIG. 4 is a diagram illustrating a group segment table 400 stored in the memory 144 by the group ID manager 230.

The group segment table 400 may include, as the group segment information, allocation state information STATE indicating the allocation or non-allocation of a command group for each group ID, information CURR_ALLOC indicating the current number of segments already allocated for each group ID, and information MAX_ALLOC indicating the maximum number of segments that are allowed for each group ID.

The processor 134 may allocate group IDs respectively to command groups, and determine the information MAX_ALLOC indicating the maximum number of segments, which are allowed for each group ID corresponding to a command group. FIG. 4 illustrates a case where among 10 group IDs, the processor 134 allocates the group ID ‘1’ to a write command group, allocates group ID ‘2’ to a read command group, and does not allocate the remaining group IDs to a command group.

The processor 134 may determine the maximum number of segments for each group ID as a number less than the number of all segments in the buffer 146 in order to substantially prevent one command group from monopolizing the segments in the buffer 146. The processor 134 may dynamically determine the maximum number of segments for each group ID on the basis of workload for each command group of the memory system 110.

Furthermore, the sum of the maximum numbers of segments for each group ID may not be limited to the total number of all segments in the buffer 146. For example, when the total number of all segments in the buffer 146 is ‘100’, the processor 134 may determine the maximum number of segments allowed for the group ID ‘1’ as ‘50’, and determine the maximum number of segments allowed for the group ID ‘2’ as ‘70’. When the current number of segments already allocated for the group ID ‘1’ is ‘40’, even though the maximum number of segments allowed for the group ID ‘2’ is ‘70’, the processor 134 may allocate maximum 60 segments for commands corresponding to the group ID ‘2’. When the current number of segments already allocated for the group ID ‘1’ is ‘10’, the processor 134 may allocate maximum 70 segments for the commands corresponding to the group ID ‘2’. When the processor 134 determines the maximum number of segments for each group ID such that the sum of the maximum numbers of segments for each group ID is greater than the total number of all segments in the buffer 146, the number of segments that are allowed for each command group may be flexibly adjusted according to a change in the workload for each command group.

The group ID manager 230 may determine the number of free segments to be allocated for a command in response to the segment allocation request from the host I/F 132, by referring to the group segment table 400.

FIG. 5 is a diagram illustrating a segment allocation table 500 stored in the memory 144 by the segment manager 250.

Each of the plurality of segments included in the buffer 146 may be identified by an index INDEX. The segment allocation table 500 may include, as the segment allocation information, allocation state information STATE of the segment for each index, corresponding buffer ID information buffer ID, and corresponding group ID information group ID.

The segment manager 250 may determine free segments to be allocated for a command in response to the segment allocation request, on the basis of the number of free segments to be allocated for the command in response to the segment allocation request and the allocation state information STATE of the segment allocation table 500. For example, when the group ID manager 230 determines to allocate two free segments, the segment manager 250 may allocate, for the command, free segments of indexes ‘6’ and ‘7’ indicated as a free (i.e., unallocated) state in the segment allocation table 500.

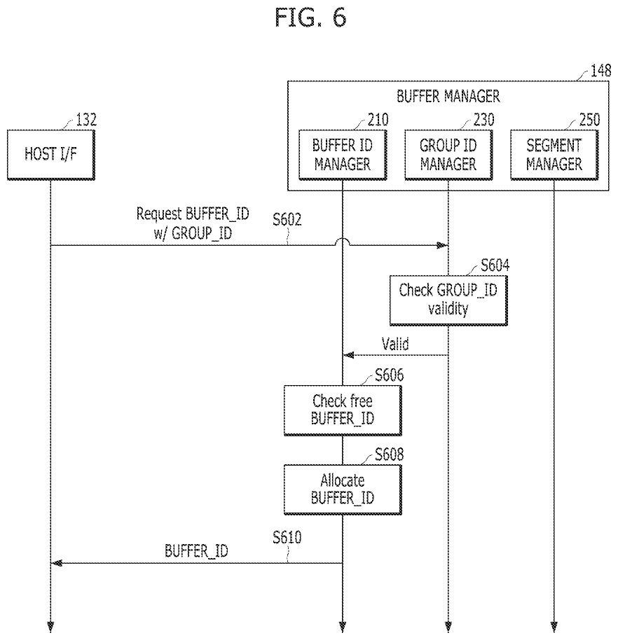

Hereinafter, the operation of the buffer manager 148 according to the buffer ID allocation request and the segment allocation request will be described with reference to FIG. 6 and FIG. 7.

FIG. 6 is a diagram for describing an operation of the buffer manager 148 according to the buffer ID allocation request.

In operation S602, the host I/F 132 may provide the buffer ID allocation request to the buffer manager 148 in order to buffer data corresponding to a command. The buffer ID allocation request may include a group ID that is determined according to an attribute of the command.

In operation S604, the group ID manager 230 may refer to the group segment table 400 and determine whether the group ID from the host I/F 132 is a valid ID. The valid group ID may refer to a group ID currently allocated for a command group. When the group ID is not the valid ID, the buffer manager 148 may send an error signal to the host I/F 132 and end the operation.

When the group ID is the valid ID, the buffer ID manager 210 may determine in operation S606 whether there are free buffer IDs in the buffer ID allocation table 300. The free buffer ID may refer to a buffer ID that is not yet allocated for a command. When there are no free buffer IDs, the buffer manager 148 may send the error signal to the host I/F 132 and end the operation.

When there are the free buffer IDs, the buffer ID manager 210 may select a buffer ID to be allocated in response to the buffer ID allocation request among the free buffer IDs, in operation S608.

In operation S610, the buffer manager 148 may provide the selected buffer ID to the host I/F 132. The host I/F 132 may allow the buffer ID to correspond to the command.

When the error signal is received from the buffer manager 148, the host I/F 132 may provide the buffer ID allocation request for the command to the buffer manager 148 again.

FIG. 7 is a diagram for describing an operation of the buffer manager 148 according to the segment allocation request.

In operation S702, in order to receive a segment for a command, the host I/F 132 may provide the buffer ID and group ID of the command to the buffer manager 148.

In operation S704, the group ID manager 230 may refer to the group segment table 400 and determine whether the group ID from the host I/F 132 is a valid ID. The valid group ID may refer to a group ID currently allocated for a command group. When the group ID is not the valid ID, the buffer manager 148 may send an error signal to the host I/F 132 and end the operation.

When the group ID is the valid ID, the buffer ID manager 210 may refer to the buffer ID allocation table 300 and determine in operation S706 whether the buffer ID from the host I/F 132 is a valid ID. The valid buffer ID may refer to a buffer ID currently allocated for a command. When the buffer ID is not the valid ID, the buffer manager 148 may send the error signal to the host I/F 132 and end the operation.

When the buffer ID is the valid ID, the segment manager 250 may determine in operation S708 whether there are free segments available in the buffer 146. A free segment available in the buffer 146 may refer to a segment that is not yet allocated and may be allocated for a command in response to the segment allocation request. When there are no free segments available in the buffer 146, the buffer manager 148 may send the error signal to the host I/F 132 and end the operation.

When there are the free segments available in the buffer 146, the group ID manager 230 may determine the number of free segments to be allocated for the command in response to the segment allocation request in operation S710. The group ID manager 230 may determine the number of free segments to be allocated for the command under the restriction of the maximum number of segments allowed for the group ID and the number of free segments available in the buffer 146. When the number of already allocated segments reaches the maximum number of segments, the buffer manager 148 may not allocate any segment in response to the segment allocation request, and may send the error signal to the host I/F 132 and end the operation.

When the number of free segments to be allocated for the command is determined, the segment manager 250 may refer to the segment allocation table 500 and allocate the determined number of free segments for the command in operation S712.

In operation S714, the buffer manager 148 may provide a segment allocation completion response Response to the host I/F 132. The host I/F 132 may use the buffer ID to access the segment allocated for the buffer ID.

When the error signal is received from the buffer manager 148, the host I/F 132 may provide the segment allocation request for the command again.

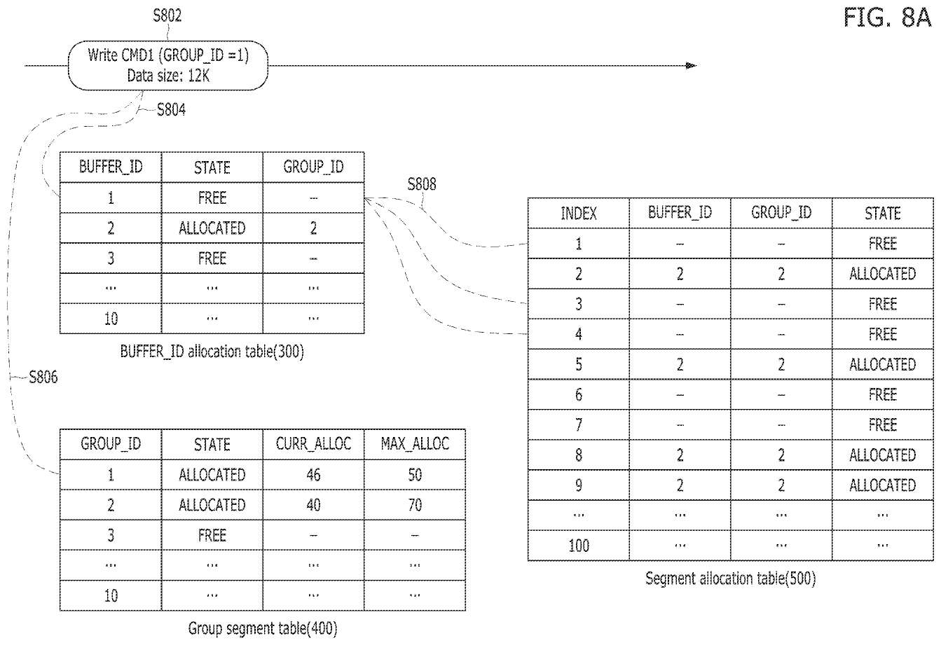

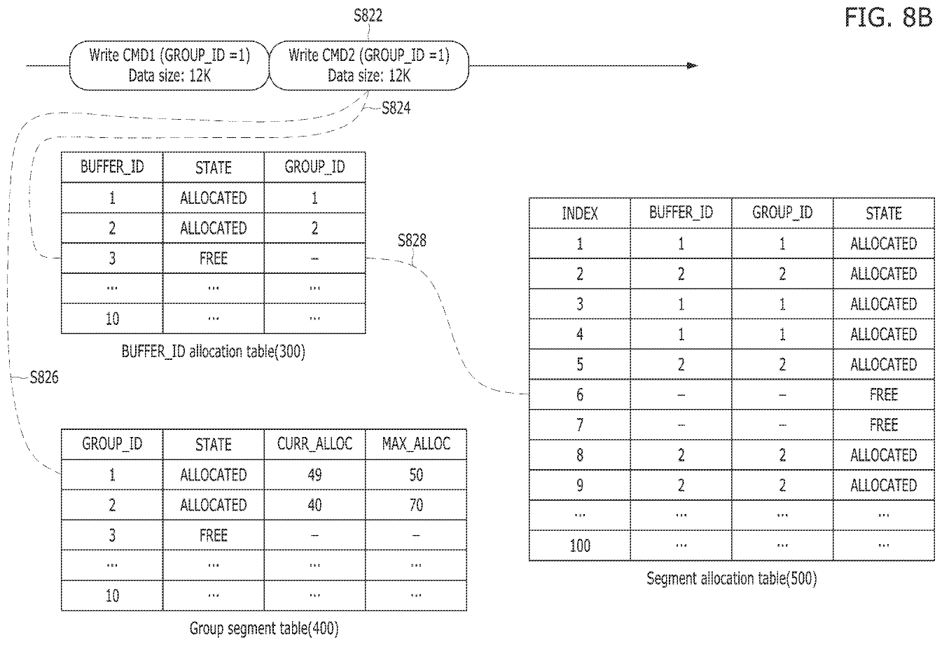

FIG. 8A and FIG. 8B are diagrams for describing an operation of the controller 130 for a command from the host 102.

Referring to FIG. 8A, in operation S802, the host I/F 132 may receive a first command CMD1. The host I/F 132 may determine the first command CMD1 as a write command and determine a group ID of the first command CMD1 as ‘1’.

In operation S804, in order to receive a buffer ID for the first command CMD1, the host I/F 132 may provide the buffer ID allocation request to the buffer manager 148 together with the group ID ‘1’.

The buffer ID manager 210 may provide the buffer ID to the host I/F 132 in response to the buffer ID allocation request. The buffer ID manager 210 may refer to the buffer ID allocation table 300 and provide the host I/F 132 with the buffer ID ‘1’ among free buffer IDs that are not yet allocated. The buffer ID manager 210 may provide the buffer ID ‘1’ to the host I/F 132, update an allocation state of the buffer ID ‘1’ to ‘allocated’ in the buffer ID allocation table 300, and update a corresponding group ID to ‘1’.

The host I/F 132 may determine a buffer ID of the first command CMD1 as ‘1’ on the basis of the response.

In operation S806, in order to receive a segment for the first command CMD1, the host I/F 132 may provide a segment allocation request to the buffer manager 148 together with the group ID ‘1’ and the buffer ID ‘1’.

The group ID manager 230 may determine the number of free segments to be allocated for the first command CMD1 in response to the segment allocation request. In order to determine the number of free segments to be allocated for the first command CMD1, the group ID manager 230 may refer to the group segment table 400. On the basis of the number of segments required for the first command CMD1, the number of free segments available in the buffer 146, the maximum number of segments allowed for the group ID ‘1’, and the current number of segments already allocated for the group ID ‘1’, the group ID manager 230 may determine the number of free segments to be allocated for the first command CMD1. The number of segments required for the first command CMD1 may be determined according to the size of data associated with the first command CMD1.

For example, the group ID manager 230 may determine the number of segments required for the first command CMD1 on the basis of the size of the data associated with the first command CMD1 and the size of each segment. The group ID manager 230 may determine the number of segments available for the group ID ‘1’ on the basis of the maximum number of segments and the current number of segments already allocated for the group ID ‘1’. The group ID manager 230 may determine the number of segments, which are to be allocated for the buffer ID ‘1’ for the first command CMD1, as the smallest number among the number of segments required for the first command CMD1, the number of free segments available in the buffer 146, and the number of segments available for the group ID ‘1’.

When the size of the data associated with the first command CMD1 is 12 KB and the size of the segment is 4 KB, the number of segments required for the first command CMD1 may be determined as ‘3’. When the total number of all segments in the buffer 146 is ‘100’ and the sum of the current number of segments already allocated for each group ID is ‘86’, the number of free segments available in the buffer 146 may be determined as ‘14’. Since the maximum number of segments allowed for the group ID ‘1’ is ‘50’ and the current number of segments already allocated for the group ID ‘1’ is ‘46’, the number of segments available for the group ID ‘1’ may be determined as ‘4’.

The number of free segments available in the buffer 146 and the number of segments available for the group ID ‘1’ may be sufficient for allocating the segments required for the buffer ID ‘1’. The group ID manager 230 may determine the number of segments, which are to be allocated for the buffer ID ‘1’, as ‘3’. The group ID manager 230 may update the current number of segments already allocated for the group ID ‘1’ to ‘49’ in the group segment table 400.

In operation S808, the segment manager 250 may refer to the segment allocation table 500 and allocate free segments for the first command CMD1 according to the number of segments to be allocated for the first command CMD1.

For example, the segment manager 250 may allocate first, third, and fourth segments identified by indexes ‘1’, ‘3’, and ‘4’ to the buffer ID ‘1’. The segment manager 250 may update allocation states of the first, third, and fourth segments to “allocated”, update the buffer ID to ‘1’, and update the group ID to ‘1’ in the segment allocation table 500.

The buffer manager 148 may provide the segment allocation completion response Response to the host I/F 132. The host I/F 132 may buffer the data associated with the first command CMD1 in the first, third, and fourth segments by using the buffer ID ‘1’.

Referring to FIG. 8B, in step S822, the host I/F 132 may receive a second command CMD2. The host I/F 132 may determine the second command CMD2 as a write command and determine a group ID of the command as ‘1’.

In operation S824, in order to receive a buffer ID for the second command CMD2, the host I/F 132 may provide the buffer ID allocation request to the buffer manager 148 together with the group ID ‘1’.

The buffer ID manager 210 may refer to the buffer ID allocation table 300 and allocate buffer ID ‘3’ which is a free buffer ID. The buffer ID manager 210 may update an allocation state of the buffer ID ‘3’ to “allocated” and update a corresponding group ID to ‘1’. The buffer ID manager 210 may provide the buffer ID ‘3’ to the host I/F 132 as a response for the buffer ID allocation request.

The host I/F 132 may determine a buffer ID of the second command CMD2 as ‘3’ on the basis of the response.

In operation S826, in order to receive a segment for the second command CMD2, the host I/F 132 may provide a segment allocation request to the buffer manager 148 together with the group ID ‘1’ and the buffer ID ‘3’.

The group ID manager 230 may determine the number of free segments to be allocated for the buffer ID ‘3’ or for the second command CMD2 in response to the segment allocation request.

For example, when the size of data associated with the second command CMD2 is 12 KB and the size of the segment is 4 KB, the number of segments required for the second command CMD2 may be determined as ‘3’. When the maximum number of segments allowed for the group ID ‘1’ is ‘50’ and the current number of segments already allocated for the group ID ‘1’ is ‘49’, the number of segments available for the group ID ‘1’ may be determined as ‘1’. When the total number of all segments in the buffer 146 is ‘100’ and the sum of the current number of segments already allocated for each group ID is ‘89’, the number of free segments available in the buffer 146 may be determined as ‘11’.

Even though the number of free segments available in the buffer 146 is sufficient for allocating the segments required for the second command CMD2, the number of segments available for the group ID ‘1’ may not be sufficient for allocating the segments required for the second command CMD2. The group ID manager 230 may determine to allocate one segment to the buffer ID ‘3’. The group ID manager 230 may update the current number of segments already allocated for the group ID ‘1’ to ‘50’ in the group segment table 400.

When one segment is allocated for the buffer ID ‘3’, the number of free segments available in the buffer 146 may be updated to ‘10’. Until the allocation of the segments allocated for the write command is released and the segments available for the group ID ‘1’ occur, 10 free segments available in the buffer 146 may not be allocated for the write command. The 10 free segments available in the buffer 146 may be allocated for a read command.

In operation S828, the segment manager 250 may refer to the segment allocation table 500 and allocate free segments for the second command CMD2 according to the determined number of segments for the second command CMD2.

For example, the segment manager 250 may allocate the sixth segment identified by the index ‘6’ to the buffer ID ‘3’. The segment manager 250 may update an allocation state of the sixth segment to “allocated”, update the buffer ID to ‘3’, and update the group ID to ‘1’ in the segment allocation table 500.

The buffer manager 148 may provide the segment allocation completion response Response to the host I/F 132. The host I/F 132 may buffer the data associated with the second command CMD2 in the sixth segment by using the buffer ID ‘3’.

In accordance with an embodiment of the present disclosure, the host I/F 132 may provide a segment allocation request to the buffer manager 148 in order to process a command. Together with the segment allocation request, the host I/F 132 may provide the buffer manager 148 with a group ID of a command group determined according to an attribute of the command. In response to the segment allocation request, the buffer manager 148 may allocate a free segment for the command under the restriction of the maximum number of segments allowed for the group ID. The host I/F 132, the processor 134, or the memory I/F 142 may use the allocated segment in order to process the command. The buffer manager 148 may limit the maximum number of segments that are allowed for one command group, thereby substantially preventing a situation which occurs when a command having one attribute monopolizes the segments in the buffer 146. Consequently, the buffer manager 148 is able to substantially prevent the performance degradation in the memory system 110.

The processor 134 may determine the group ID of the command according to various criteria for determining the attribute of the command. Then, the processor 134 may dynamically determine the maximum number of segments for each group ID on the basis of workload for each command group. Consequently, the buffer manager 148 is able to efficiently allocate limited resources of the buffer 146 to commands having various attributes on the basis of the workload for each command group.

The present disclosure described above is not limited by the aforementioned embodiments and the accompanying drawings, and it is apparent to those skilled in the art to the present disclosure pertains that various substitutions, modifications, and changes can be made without departing from the technical spirit of the present disclosure.

While the present invention has been illustrated and described with respect to specific embodiments, these embodiments are not intended to be restrictive, but rather descriptive. Further, it is noted that the present invention may be achieved in various ways through substitution, change, and modification, as would be understood by those skilled in the art, without departing from the spirit and/or scope of the present invention as defined by the following claims.

What is claimed is:

1. A controller that controls a memory device, the controller comprising:
a buffer including a plurality of segments;
a host interface configured to determine a command group of a command from a host on the basis of an attribute of the command; and
a buffer manager configured to allocate a free segment when there is available free segment among the plurality of segments in response to a segment allocation request from the host interface,
wherein the host interface is further configured to process data associated with the command by using the allocated segment.

2. The controller of claim 1,
wherein the host interface is further configured to:
provide the buffer manager with a buffer identifier (ID) allocation request to acquire a buffer ID from the buffer manager, and
provide the acquired buffer ID to the buffer manager together with the segment allocation request, and
wherein the host interface processes the data associated with the command by accessing the allocated segment according to the acquired buffer ID after the buffer manager allocates the free segment for the buffer ID.

3. The controller of claim 1, wherein the host interface is further configured to provide the buffer manager with a group ID for identifying the command group of the command together with the segment allocation request.

4. The controller of claim 3, further comprising a processor configured to allocate group IDs to command groups and determine a maximum number of segments, which are allowed for a corresponding command group, for each group ID.

5. The controller of claim 4, wherein the processor determines the maximum number of segments for each group ID to be less than a number of all segments included in the buffer.

6. The controller of claim 5, wherein the processor dynamically determines the maximum number of segments for each group ID on the basis of workload for each command group.

7. The controller of claim 3, wherein the host interface is further configured to determine the group ID of the command on the basis of a type of the command.

8. The controller of claim 3, wherein the host interface is further configured to determine the group ID of the command on the basis of a type of the command and an attribute of the data associated with the command.

9. The controller of claim 3, wherein the host interface is further configured to determine the group ID of the command differently for each command.

10. The controller of claim 3,
wherein the buffer manager is further configured to determine a number of free segments to be allocated for the command on the basis of a maximum number of segments allowed for the group ID of the command, a current number of segments already allocated for the group ID, a number of segments required for processing the command and a number of free segments available in the buffer, and
wherein the buffer manager allocates the free segment for as many as the determined number of free segments to be allocated for the command.

11. The controller of claim 10,
wherein the buffer manager is further configured to determine a number of segments available for the group ID on the basis of the maximum number of segments allowed for the group ID of the command and the current number of segments already allocated for the group ID, and
wherein the buffer manager determines, as the number of free segments to be allocated for the command, a smallest number among the number of segments available for the group ID, the number of segments required for the group ID, and the number of free segments available in the buffer.

12. The controller of claim 11, wherein the buffer manager is further configured to provide, in response to the segment allocation request, an error signal to the host interface without the allocating of the free segment when the number of available segments for the group ID or the number of free segments available in the buffer is ‘0’.

13. The controller of claim 10, wherein the buffer manager is further configured to determine the number of segments required for the group ID on the basis of a size of the data associated with the command and a size of the segment.

14. An operation method of a controller that controls a memory device, the operation method comprising:
determining a command group of a command from a host on the basis of an attribute of the command;
allocating a free segment among a plurality of segments included in a buffer of the controller; and
processing data associated with the command by using the allocated segment.

15. The operation method of claim 14,
further comprising allocating a buffer ID corresponding to the command,
wherein the allocating of the free segment comprises allocating the free segment for the buffer ID, and
wherein the processing of the data associated with the command by using the allocated segment comprises accessing the allocated segment according to the buffer ID after the allocating of the free segment for the buffer ID.

16. The operation method of claim 14, further comprising determining a group ID for identifying the command group of the command.

17. The operation method of claim 16,
further comprising:
allocating group IDs to command groups; and
determining a maximum number of segments, which are allowed for a corresponding command group, for each group ID,
wherein the maximum number is less than a number of all segments included in the buffer.

18. The operation method of claim 17, wherein the determining of the maximum number of segments comprises dynamically determining the maximum number of segments for each group ID on the basis of workload for each command group.

19. The operation method of claim 16, wherein the allocating of the free segment comprises allocating the free segment for as many as a number that is determined on the basis of a maximum number of segments allowed for the group ID of the command, a current number of segments already allocated for the group ID, a number of segments required for processing the command, and a number of free segments available in the buffer.

20. An operating method of a controller, the operating method comprising:
allowing, within a buffer comprising plural segments, a size for a request group;
allocating, within the allowed size, one or more available segments among the segments in response to a request belonging to the request group; and
controlling, with the allocated segments, a memory device to perform an operation in response to the request,
wherein the allowed size is less than a whole size of the buffer.
